(19) United States
(12) Patent Application Publication
(10) Pub. No.: US 2017/0140649 A1
(43) Pub. Date: May 18, 2017

(54) PARKING LIMIT NOTIFICATION SYSTEM

(71) Applicant: HARMAN INTERNATIONAL INDUSTRIES, INC., Stamford, CT (US)

(72) Inventors: Davide Di Censo, Oakland, CA (US); Stefan Marti, Oakland, CA (US); Jaime Elliot Nahman, Oakland, CA (US)

(21) Appl. No.: 14/945,351

(22) Filed: Nov. 18, 2015

(51) Int. Cl. G08G 1/14

(52) U.S. Cl. CPC G08G 1/146

(57) ABSTRACT

A notification system is configured to determine a set of parking restrictions associated with a parking space where a driver parks a vehicle. The set of parking restrictions indicate a particular allotment of time that the vehicle may be parked in the parking space. The notification system then sets a timer that reflects the allotment of time. The notification system also determines a set of contextual constraints associated with the driver that limit the ability of the driver to return to the vehicle. The notification system computes an amount of buffer needed for the driver to return to the vehicle, based on the set of contextual constraints. When the amount of time remaining on the timer is equal to the buffer, the notification system notifies the driver that a parking violation is imminent, providing the driver with sufficient time to return to the vehicle and address the situation.

### BACKGROUND

Field of the Disclosed Embodiments

The disclosed embodiments relate generally to in-vehicle notification systems and, more specifically, to a parking limit notification system.

Description of the Related Art

Avoiding parking tickets is a common objective for many, if not all, drivers of motorized vehicles. As is well-known, parking tickets are issued when a vehicle is parked in violation of the law. Laws governing the parking of vehicles are typically posted on parking signs near parking spaces. A parking sign may dictate a specific allotment of time that a vehicle may park in a given parking space or the type of vehicle allowed in the given parking space. For example, a parking sign could stipulate “two hour parking only,” indicating that a vehicle may be parked in the corresponding parking space for a maximum of two hours, or “commercial vehicles only,” indicating that non-commercial vehicles, such as most cars, are not allowed to park in the corresponding parking space. In some cases, a parking meter must be paid in order to purchase a specific allotment of parking time for a given parking space. In these given situations, if the allotment of time associated with the parking space is exceeded, if an unauthorized vehicle parks in the parking space, or if the time on the parking meter associated with the parking space expires, a parking ticket may be issued.

Certain factors typically impede the ability of drivers to avoid receiving parking tickets. A frequently recurring scenario is when a driver does not have sufficient time to return to his/her vehicle before a parking violation occurs. For example, the driver could be preoccupied with other activities or delayed by unforeseen circumstances, among other possibilities. Another common scenario is when the parking rules dictated by a given parking sign, are difficult to see or inordinately complex such that a driver does not see a particular parking restriction or has difficulty understanding whether parking in a given parking space is legal or how long a vehicle may be parked in the parking space.

As the foregoing illustrates, more effective techniques for avoiding parking tickets would be useful for many drivers.

### SUMMARY

One or more embodiments set forth include a non-transitory computer-readable medium storing program instructions that, when executed by a processor, configure the processor to perform the steps of obtaining a set of parking restrictions that govern the use of a parking space, obtaining a set of contextual constraints associated with a driver of a vehicle, and notifying the driver to return to the vehicle based on the set of parking rules and the set of contextual constraints.

At least one advantage of the disclosed embodiments is that the driver of a vehicle can be notified of potential parking violations with sufficient time to return to the vehicle, thereby avoiding costly parking fines.

### BRIEF DESCRIPTION OF THE SEVERAL VIEWS OF THE DRAWINGS

So that the manner in which the recited features of the one more embodiments set forth above can be understood in detail, a more particular description of the one or more embodiments, briefly summarized above, may be had by reference to certain specific embodiments, some of which are illustrated in the appended drawings. It is to be noted, however, that the appended drawings illustrate only typical embodiments and are therefore not to be considered limiting of its scope in any manner, for the scope of the disclosed embodiments subsumes other embodiments as well.

FIGS. 1A-1B illustrate a notification system configured to implement one or more aspects of the various embodiments;

FIGS. 2A-2C illustrate an exemplary scenario where the notification system of FIG. 1A notifies a driver of a vehicle that an allotted parking time may soon expire, according to various embodiments;

FIGS. 3A-3B illustrate exemplary logic diagrams for determining when to notify a driver of a vehicle that a parking violation may occur, according to various embodiments; and

FIG. 4 is a flow diagram of method steps for providing advance notice to a driver of a vehicle that a parking violation may occur, according to various embodiments.

### DETAILED DESCRIPTION

In the following description, numerous specific details are set forth to provide a more thorough understanding of certain specific embodiments. However, it will be apparent to one of skill in the art that other embodiments may be practiced without one or more of these specific details or with additional specific details.

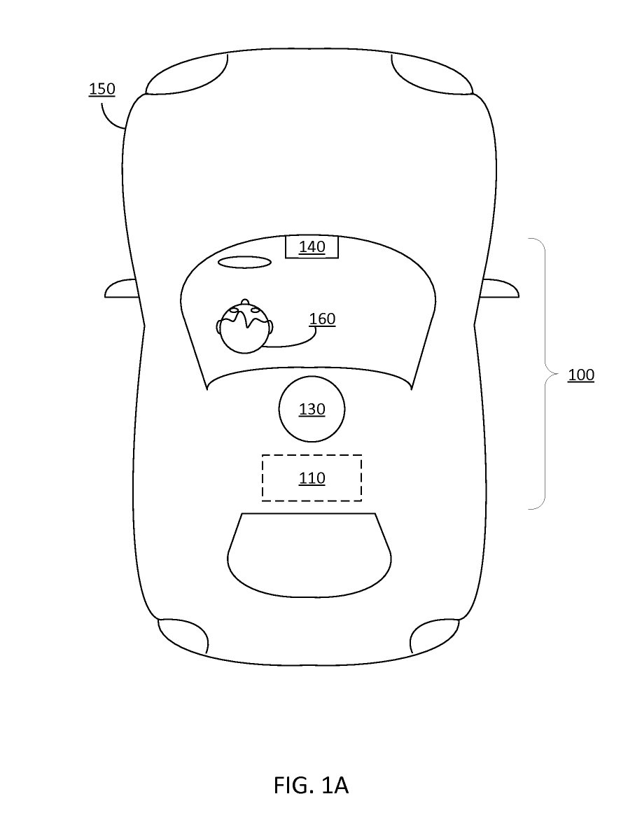

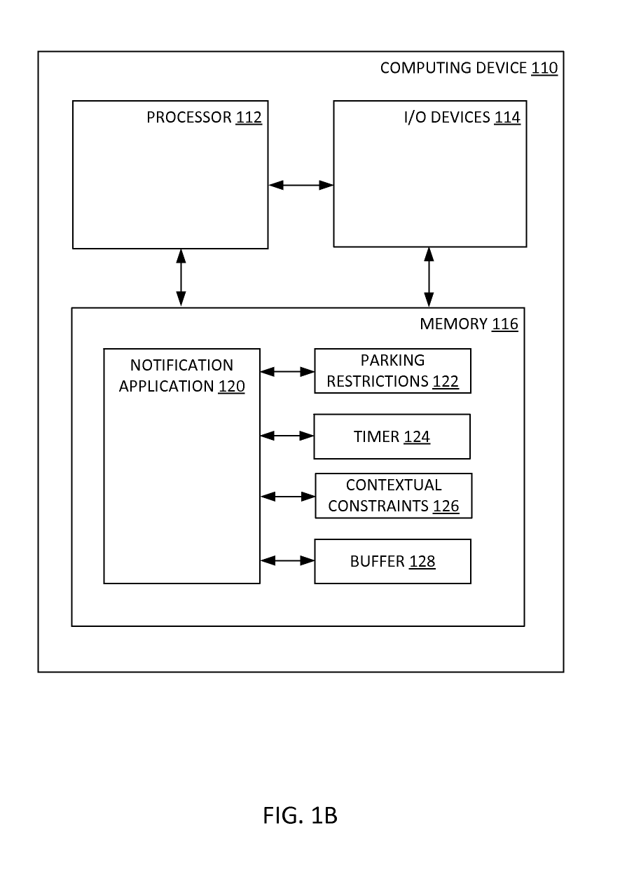

FIGS. 1A-1B illustrate elements of a notification system configured to implement one or more aspects of the various embodiments. As shown in FIG. 1A, a notification system 100 includes, without limitation, a computing device 110, a sensor array 130, and an output array 140. Notification system 100 resides within a vehicle 150 that is driven by a driver 160.

When driver 160 parks vehicle 150 in a parking space, notification system 100 is configured to determine a set of parking restrictions associated with the parking space, and to then notify driver 160 when those restrictions are potentially violated. In doing so, notification system 100 accounts for the current context of driver 160 in order to provide sufficient time for driver 160 to return to vehicle 150. For example, and without limitation, if vehicle 150 is parked in a two-hour parking zone, and driver 160 is located 30 minutes away from vehicle 150, notification system 100 would notify driver 160 30 minutes before the two-hour allotment expires that vehicle 150 should be moved. In another example, and without limitation, if vehicle 150 is parked in a metered parking space and driver 160 is located 10 minutes away from vehicle 150, notification system 100 would notify driver 160 10 minutes before the meter expires. Thus, notification system 100 provides driver 160 with sufficient time to return to vehicle 150 and avoid a parking violation. In this fashion, notification system 100 may assist driver 160 with avoiding parking tickets.

In operation, sensor array 130 is configured to obtain sensor data associated with one or more parking signs that indicate a set of parking restrictions. The parking restrictions generally govern parking spaces nearby vehicle 150. Sensor array 130 may be any technically feasible type of sensor, including outward facing-sensors such as optical sensors, infrared (IR), laser-based sensors, and so forth. Sensor array 130 may also include multiple sensors mounted on a mechanically actuated pan-tilt-zoom (PTZ) head. Computing device 110 is configured to process the sensor data to extract the set of restrictions associated with the nearby parking spaces. Computing device 110 may reside within vehicle 150 or be entirely or partially cloud-based. Computing device 110 may rely on computer vision techniques, artificial intelligence, machine learning, rule-based learning, and so forth, in order to process the sensor data and extract the set of parking restrictions. An exemplary computing device 110 is illustrated in FIG. 1B.

As shown in FIG. 1B, computing device 110 includes, without limitation, a processor 112, input/output (I/O) devices 114, and a memory 116. Memory 116 includes a notification application 120, parking restrictions 122, a timer 124, contextual constraints 126, and a buffer 128. Processor 112 may be any technically feasible form of hardware configured to process data, including, for example, and without limitation, a central processing unit (CPU), an application-specific integrated circuit (ASIC), a microprocessor, and so forth. I/O devices 114 may include devices configured to receive input, such as a keyboard, a touchpad, and so forth, without limitation, devices configured to generate output, such as a video display, a speaker, and so forth, without limitation, and/or devices configured to both receive input and generate output, such as a universal serial bus (USB) port, touchscreen, and so forth, without limitation. Memory 116 may be any technically feasible storage medium, including, for example, and without limitation, a hard disk, a random access memory (RAM) module, a read-only memory (ROM) module, and so forth.

Notification application 120 includes program code that, when executed by processor 112, coordinates the general operation of notification system 100. In doing so, notification application 120 receives sensor data from sensor array 130 that is associated with parking signs, and then processes that sensor data to extract parking restrictions 122 associated with those signs and corresponding parking spaces. Parking restrictions 122 could indicate, for example, and without limitation, particular times when parking is permitted, specific allotments of time during which a vehicle may be parked, certain zones where vehicles may park, and so forth.

In one embodiment, notification application 120 may retrieve parking restrictions 122 associated with a given parking space based on global navigation satellite system (GNSS) or global positioning system (GPS) coordinates corresponding to the parking space. Notification application 120 could, for example, and without limitation, access a GNSS or GPS-indexed database of parking restrictions. In another embodiment, notification application 120 may acquire parking restrictions based on vehicle-to-infrastructure (V2I), vehicle-to-vehicle (V2V), vehicle-to-anything (V2X), or peer-to-peer (P2P) communication. In yet another embodiment, notification application 120 may acquire parking restrictions 124 through interaction with wireless beacons associated with parking spaces, barcodes or quick response (QR) codes present on parking signs, near-field communication (NFC) devices embedded in parking spaces, or through direct interaction with driver 160. Based on parking restrictions 122, notification application 120 initiates timer 124.

Timer 124 is a countdown clock that measures an amount of time remaining before vehicle 150 may violate a parking restriction associated with a parking space where vehicle 150 is currently parked. For example, and without limitation, if parking restrictions 122 indicates that a current parking space cannot be used after 3 PM, then notification application 120 would configure timer 124 to countdown an amount of time until 3 PM.

Notification application 120 also collects various contextual constraints 126 associated with driver 160. As referred to herein, a “contextual constraint” associated with driver 160 refers to any sort of environmental factor that limits the ability of driver 160 to return to vehicle 150. For example, and without limitation, the current location of driver 160 could limit the ability of driver 160 from returning to vehicle 150 in less than 15 minutes. In another example, without limitation, the daily schedule of driver 160 could prohibit driver 160 from returning to vehicle 150 after 9 AM. In yet another example, without limitation, an event occurring near driver 160 could impede the ability of driver 160 to return to vehicle 150 in less than 30 minutes. Notification application 120 may track the location of driver 160, process the daily schedule of driver 160, and/or observe scheduled events occurring near driver 160 or vehicle 150 in order to generate contextual constraints 126. Based on contextual constraints 126, notification application 120 generates buffer 128.

Buffer 128 represents an amount of time before the expiration of timer 124 that driver 160 should be notified. Buffer 128 accounts for any technically feasible delays of time that driver 160 may incur, including, for example, travel delays, delays due to activities of driver 160, and delays due to scheduled events, and so forth, without limitation. Buffer 128 may also change size based on variations in contextual constraints 126. For example, and without limitation, as the location of driver 160 changes, the size of buffer 128 may change in corresponding fashion.

In one embodiment, notification application 120 may update timer value 124 based on contextual constraints 126. For example, and without limitation, notification application 120 could determine that although vehicle 150 is parked in a two-hour parking space, driver 160 has an appointment in one hour what would prevent driver 160 from returning to vehicle 150 and moving vehicle 150 to a new parking space. Thus, notification application 120 may initially set timer 124 to one hour.

Referring generally to FIGS. 1A-1B, notification application 120 within notification system 100 is configured to notify driver 160, based on parking restrictions 122 and based on contextual constraints 126, when those parking restrictions may potentially be violated. In doing so, notification application 120 may communicate with driver 160 via one or more different modes of communication, depending on the location of driver 160. For example, and without limitation, notification application 120 may transmit a short message service (SMS) to a mobile device associated with driver 160, send an electronic mail (email) to driver 160, or post a message to a social networking service account associated with driver 160 when driver 160 resides outside of vehicle 150 and a parking violation is imminent. Alternatively, and without limitation, notification application 120 could generate audio or visual output directly to driver 160 via output array 140 when driver 160 resides inside vehicle 150 and a parking violation is imminent. Output array 140 may include any technically feasible type of device capable of generating output, including, for example, audio output devices, video output devices, haptic output devices, neural stimulation devices, and so forth, without limitation.

Driver 160 may receive notifications transmitted by notification application 120 and then return to vehicle 150 to address the potential parking violation. Driver 160 could, for example, and without limitation, feed an expiring parking meter. Alternatively, and without limitation, driver 160 could move vehicle 150 to a different parking space. By implementing notification system 100 within a vehicle 150, parking violations and, thus, parking tickets, may be avoided.

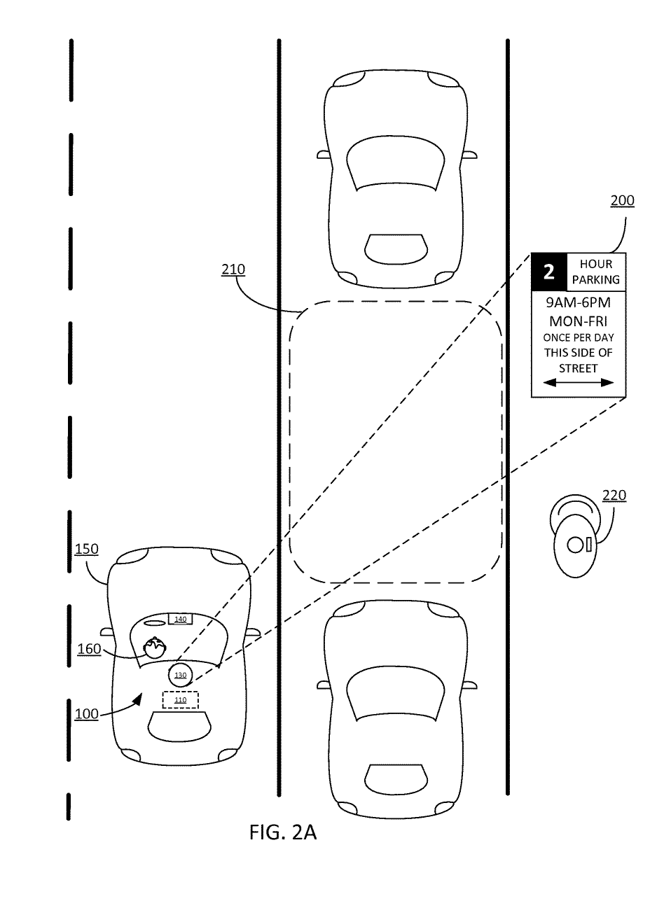

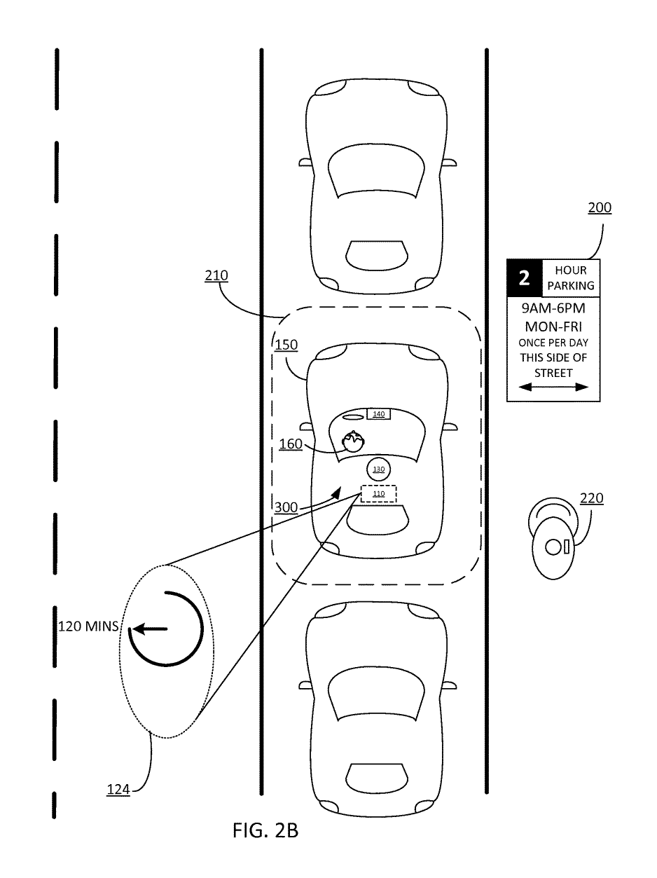

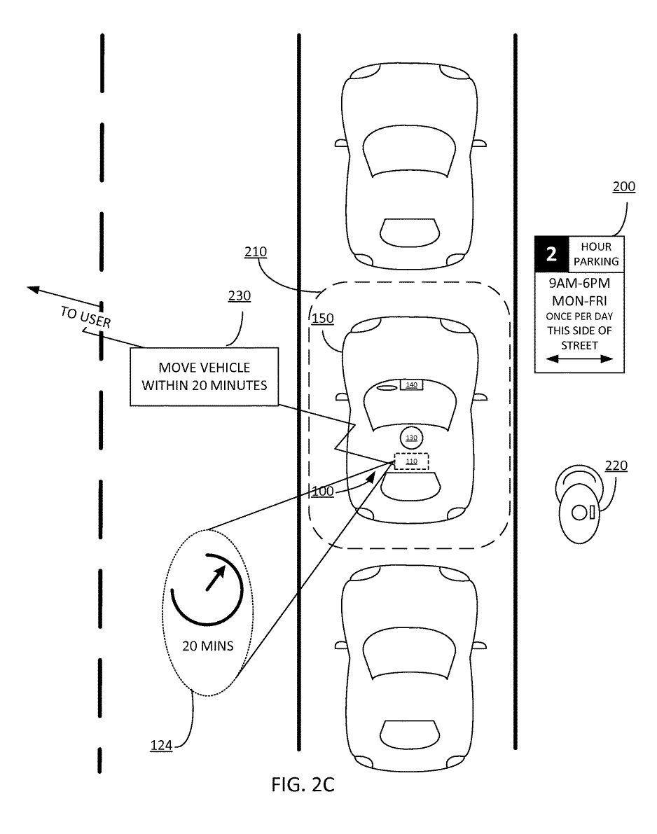

FIGS. 2A-2C illustrate an exemplary scenario where the notification system of FIG. 1A notifies a driver of a vehicle that an allotted parking time may soon expire, according to various embodiments. As shown in FIG. 2A, driver 160 drives vehicle 150 along a roadway lined with parking spaces. A parking sign 200 is positioned proximate to a set of parking spaces and dictates a set of restrictions that govern those parking spaces. One such parking space, parking space 200, is unoccupied. In some embodiments, a meter 220 is associated with parking space 210 and/or parking sign 200.

Sensor array 130 is configured to gather data associated with parking sign 200 for processing by notification application 120 within notification system 100. In one embodiment, sensor array 130 gathers data within a 360 degree panorama or spherical area that surrounds vehicle 150, and notification application 120 then processes that data to identify parking signs, such as parking sign 200. Based on sensor data associated with parking sign 200, notification application 120 determines a set of parking restrictions, such as parking restrictions 122 shown in FIG. 1B, that govern the usage of parking space 210. In the exemplary scenario discussed herein, parking sign 200 indicates that a vehicle may be parked in parking space 210 for a maximum of two hours between the hours of 9 AM and 6 PM, Monday through Friday, only once per day and only on the side of the street where parking sign 200 is located.

Referring now to FIG. 2B, notification application 120 processes the text of parking sign 200 and then generates parking restrictions 122 reflective of parking sign 200. Notification application 120 also generates contextual constraints 126 that reflect various limitations associated with driver 160, as described above in conjunction with FIG. 1B. Based on parking restrictions 122, and based on contextual constraints 126, notification application 120 initiates timer 124. In the example depicted in FIG. 2B, timer 124 initially reflects the maximum amount of time that vehicle 150 may be parked in parking space 210, i.e., two hours. In some embodiments, timer 124 reflects an amount of time remaining on meter 220. Notification application 120 may then compute a value for buffer 128 based on contextual constraints 126 associated with driver 160. For example, notification application 120 could determine that driver 160 needs 20 minutes to return to vehicle 150 in order to move vehicle 150 (or to feed meter 220, in such embodiments).

Referring now to FIG. 2C, when timer 124 decrements to the value of buffer 128, notification application 120 transmits a notification 230 to driver 160 indicating that vehicle 150 should be moved within 20 minutes in order to avoid a parking violation. Again, notification application 120 is configured to maintain buffer 128 to account for contextual constraints associated with driver 160, and to then notify driver 160 before timer 124 expires, based on buffer 128. Notification application 120 may iteratively apply contextual constraints 124 in order to compute and re-compute buffer 128 based on changes to those contextual constraints. For example, and without limitation, if driver 160 changes locations, the amount of time needed for driver 160 to return to vehicle 150 could likewise change.

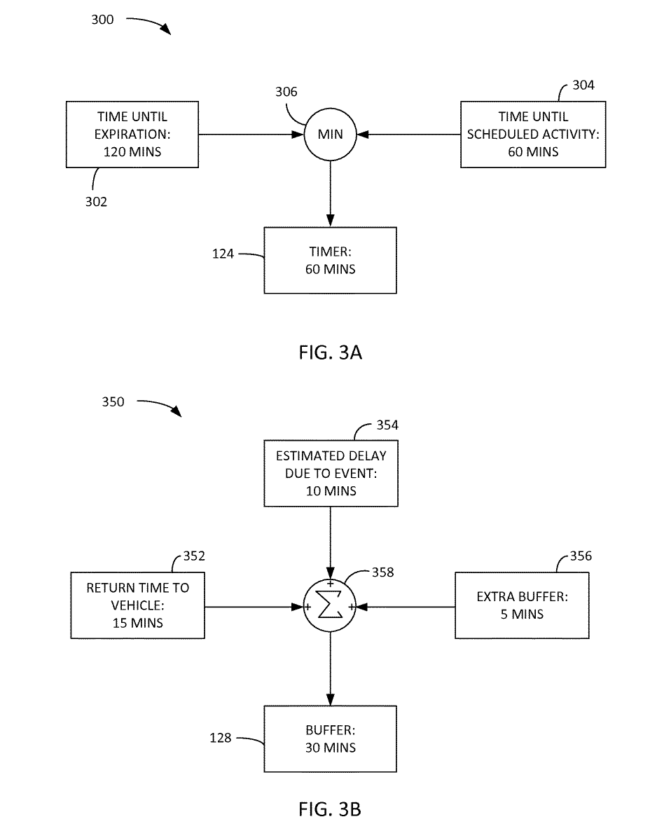

Referring generally to FIGS. 2A-2C, persons skilled in the art will understand that the exemplary scenario discussed above is provided for illustrative purposes only and not meant to be limiting in any way. As a general matter, notification application 120 may rely on a wide variety of different techniques for notifying driver 160, at the appropriate time, that a situation related to the parking of vehicle 150 should be addressed. One technique for computing the value of timer 124 and buffer 128 is discussed below in conjunction with FIGS. 3A-3C.

FIGS. 3A-3B illustrate exemplary logic diagrams for determining when to notify a driver of a vehicle that a parking violation may occur, according to various embodiments. As shown in FIG. 3A, logic 300 includes an initial time until expiration 302, a time until scheduled activity 304, timer 124, and a minimum operator (min) 306. Initial time until expiration 302 represents the specific amount of time allotted for the parking of vehicle 150, as indicated by a parking sign, such as parking sign 200, or a parking meter, such as meter 220. Time until scheduled activity 304 reflects an amount of time until driver 160 is scheduled to be elsewhere (and therefore not able to return to vehicle 150). For example, driver 160 may be scheduled to attend a meeting in one hour, and so time until scheduled activity 304 would reflect this amount of time. Minimum 306 is implemented by notification application 120 to compute the minimum value between time until expiration 302 and time until scheduled activity 304, thereby generating an initial value for timer 124.

Notification application 120 may execute logic 300 in situations where the allotted parking time expires at a time when driver 160 is unable to move vehicle 150, or feed meter 220, due to a previously scheduled activity. Returning to the above example, if the allotted parking time expires in two hours, driver 160 may still be at the scheduled meeting, and therefore not able to return to vehicle 150. Thus, notification application 120 determines that timer 124 should be set to expire before the previously scheduled activity, thereby providing driver 160 with sufficient time to move vehicle 150 before the scheduled activity. Notification application 120 may perform an alternate process when computing buffer 128 based on contextual constraints 126, as described below in conjunction with FIG. 3B.

As shown in FIG. 3B, logic 350 includes various contextual constraints, such as return time to vehicle 352, estimated delay due to event 354, and extra buffer 356, as well as sum operator 358 and buffer 128. Return time to vehicle 352 is simply an estimated amount of time that driver 160 needs to return to vehicle 150. Notification application 120 may compute this value based on, for example, and without limitation, the current location of driver 160 relative to vehicle 150, the average walking speed on driver 160, and so forth. Estimated delay due to event 354 represents an amount of delay that driver 160 may experience when returning to vehicle 150. This delay could be reflective of events such as, for example, and without limitation, construction projects, street closures, accidents, and other environmental or city-based events. Extra buffer 356 represents a configurable value that may be set by driver 160. Sum operator 358 is implemented by notification application 120 and configured to combine the various contextual constraints shown to generate a value for buffer 128. Generally, notification application 120 implements logic 350 in order to determine the total amount of time that driver 160 needs to return to vehicle 150 upon being notified.

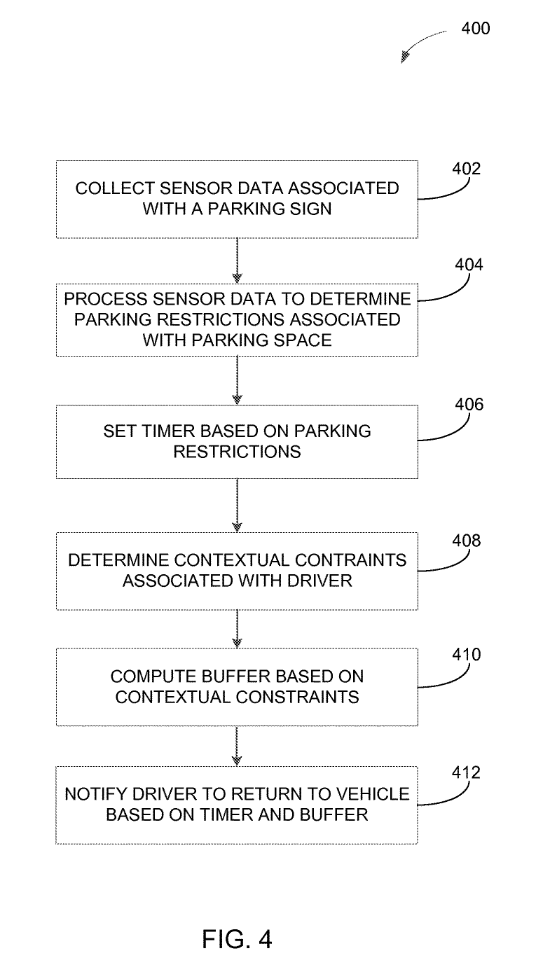

Referring generally to FIGS. 3A-3B, notification application 120 may implement logic 300 and 350 to compute values for timer 124 and buffer 128, respectively, and then notify driver 160 to return to vehicle 150 an amount of time before the expiration of timer 124 that is equal to the value of buffer 128. Persons skilled in the art will recognize that logic 300 and 350 discussed above are meant for illustrative purposes only, and not meant to be limiting. Notification application 120 may implement a wide range of techniques for scheduling the transmission of a notification. The general approach employed by notification application 120 is described in stepwise fashion below in conjunction with FIG. 4.

FIG. 4 is a flow diagram of method steps for providing advance notice to a driver of a vehicle that a parking violation may occur, according to various embodiments. Although the method steps are described in conjunction with the systems of FIGS. 1-3B, persons skilled in the art will understand that any system configured to perform the method steps, in any order, is within the scope of the disclosed embodiments.

As shown, a method 400 begins at step 402, where sensor array 130 within notification system 100 collects sensor data associated with a parking sign corresponding to a parking space. The parking sign could be, for example, and without limitation, parking sign 200 shown in FIGS. 2A-2C. In one embodiment, sensor array 130 may also collect sensor data associated with a parking meter, such as, for example, and without limitation, parking meter 220 shown in FIGS. 2A-2C. In such embodiments, notification system 100 may detect when meter 220 has expired or is expiring soon and then notify the driver accordingly. Alternatively, notification application 120 may communicate wirelessly with meter 220 to determine an amount of metered time remaining, and then update the driver accordingly.

At step 404, notification application 120 within notification system 100 processes the sensor data collected at step 402 to determine parking restrictions associated with the parking space. The parking restrictions could be, for example, and without limitation, parking restrictions 122 shown in FIG. 1B. The parking restrictions could also be restrictions associated with a parking garage where the driver intends to park the vehicle. In one embodiment, notification system 100 determines that parking in the associated parking space is illegal, and may then advise the driver to avoid parking in that parking space.

At step 406, notification application 120 sets a timer based on the parking restrictions that reflects a countdown to a time when those parking restrictions may be violated. Generally, notification application 120 performs step 406 upon determining that the driver has parked the vehicle in the parking space. The timer could be, for example, and without limitation, timer 124 shown in FIGS. 1B and 2A-3A. In one embodiment, notification application 120 only sets the timer after a parking enforcement agent observes the vehicle, e.g., to chalk the tires of the vehicle, without limitation.

At step 408, notification application 120 determines one or more contextual constraints associated with the driver of the vehicle. The contextual constraints generally reflect one or more environmental factors that limit the ability of the driver to return to the vehicle. The contextual constraints could be, for example, and without limitation, contextual constraints 126 shown in FIGS. 1B and 3B.

At step 410, notification application 120 computes a buffer that should provide the driver with sufficient time to return to the vehicle. The buffer generally accounts for the various contextual constraints determined at step 408. The buffer could be, for example, and without limitation, buffer 128 shown in FIGS. 1B and 3B.

At step 412, notification application 130 notifies the driver to return to the vehicle based on the timer set at step 406 and the buffer computed at step 410. In doing so, notification application 120 may transmit an SMS message, send an email, post to social network, communicate with an application installed on a mobile device associated with the driver, or rely on any other technically feasible form of communication. The driver, upon receipt of the notification, may have sufficient time to return to the vehicle and take action to avoid a parking ticket. Thus, by implementing the method 400, notification system 100 may help drivers of vehicles avoid costly fines associated with parking tickets.

The general approach implemented by notification system 100 may be expanded in a number of different ways according to several related embodiments. In embodiments where meter 220 monitors the usage of parking space 210, notification application 120 may wirelessly pay meter 220 when that meter is close to expiration. Notification application 120 may determine an amount to pay meter 220 based on contextual constraints 126 associated with driver 160. For example, and without limitation, notification application 120 could determine that driver 160 needs 10 minutes to return to vehicle 150, and then pay meter 220 for only 10 minutes of additional parking time. In another embodiment, notification application 120 may interact with an automated parking pass machine in order to acquire a parking pass. For example, and without limitation, notification application 120 could provide payment to the parking pass machine and then acquire a digital version of a parking pass. Notification application 120 could then cause the parking pass to be printed within vehicle 150 and placed on the dashboard of that vehicle. Alternatively, notification application 120 could project an image of the parking pass on the dashboard, e.g., via a pico projector, without limitation.

In other embodiments, vehicle 150 may be configured to launch an autonomous drone configured to assist notification application 120 with various actions. For example, and without limitation, notification application 120 could rely on the autonomous drone to gather sensor data on behalf of sensor array 130. In situations where a parking sign is obstructed and therefore not visible to sensor array 130 or driver 160, the autonomous drone could record sensor data from a different vantage point and provide that data to notification application 120 for processing and/or display to driver 160. The autonomous drone may also perform other tasks, including feeding a parking meter, scanning for traffic enforcement officers, removing chalk from the tires of vehicle 150, distracting traffic enforcement, locating driver 160, and so forth. The autonomous drone may be a flying drone, such as a quadcopter, for example, and without limitation. Alternatively, the autonomous drone could simply be a device that attaches to a parking meter and inserts coins into the meter on an as-needed basis, for example, and without limitation. In one embodiment, vehicle 150 itself can perform any of the functionality of the above-mentioned autonomous drone, including washing chalk off of tires.

Persons skilled in the art will recognize that all of the techniques described herein are equally applicable to driverless vehicles as well as traditional manually-operated vehicles. For example, notification application 120, upon determining that an allotted amount of parking time has expired, may notify software that operates a driverless vehicle that the vehicle should be re-parked. The driverless vehicle may then identify a new parking space, park, and notify the driver of the location of the new parking space.

In sum, a notification system is configured to determine a set of parking restrictions associated with a parking space where a driver parks a vehicle. The set of parking restrictions indicate a particular allotment of time that the vehicle may be parked in the parking space. The notification system then sets a timer that reflects the allotment of time. The notification system also determines a set of contextual constraints associated with the driver that limit the ability of the driver to return to the vehicle. The notification system computes an amount of buffer needed for the driver to return to the vehicle, based on the set of contextual constraints. When the amount of time remaining on the timer is equal to the buffer, the notification system notifies the driver that a parking violation is imminent, providing the driver with sufficient time to return to the vehicle and address the situation.

At least one advantage of the disclosed techniques is that the driver of a vehicle can be notified of potential parking violations with sufficient time to return to the vehicle, thereby avoiding costly parking fines. In addition, the burden of reading and understanding complex parking signs, and monitoring an allotment of time provided for a parking space, may be removed from the driver, allowing the driver to focus on other activities.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A non-transitory computer-readable medium storing program instructions that, when executed by a processor, configure the processor to perform the steps of:
obtaining, at a computing device residing within a vehicle, a set of parking restrictions that govern the use of a parking space;
obtaining a set of contextual constraints associated with a driver of the vehicle; and
notifying the driver to return to the vehicle based on the set of parking restrictions and the set of contextual constraints.

2. The non-transitory computer-readable medium of claim 1, further comprising setting a timer based on the set of parking restrictions, wherein the timer indicates a first amount of time until at least one parking restriction is violated.

3. The non-transitory computer-readable medium of claim 2, further comprising generating a buffer value based on the set of contextual constraints, wherein the buffer value indicates a total amount of time the driver has to return to the vehicle.

4. The non-transitory computer-readable medium of claim 3, wherein the set of contextual constraints comprises at least one of an amount of time the driver has to return to the vehicle, an estimated amount of delay to be incurred as the driver returns to the vehicle, and an amount of extra buffer time.

5. The non-transitory computer-readable medium of claim 3, wherein the driver is notified to return to the vehicle when an amount of time remaining on the timer is equal to the buffer value.

6. The non-transitory computer-readable medium of claim 1, wherein obtaining the set of parking restrictions comprises:
receiving sensor data associated with a parking sign corresponding to the parking space; and
processing the sensor data to extract the set of parking restrictions.

7. The non-transitory computer-readable medium of claim 1, wherein obtaining the set of parking restrictions comprises:
receiving global navigation satellite system (GNSS) coordinates associated with the parking space; and
accessing a database, based on the GNSS coordinates, to extract the set of parking restrictions.

8. The non-transitory computer-readable medium of claim 1, wherein notifying the driver to return to the vehicle comprises notifying the driver that an allotted time dictated by the set of parking restrictions is set to expire in a first amount of time.

9. The non-transitory computer-readable medium of claim 1, wherein notifying the driver to return to the vehicle comprises notifying the driver that a parking meter associated with the parking space is set to expire in a first amount of time.

10. The non-transitory computer-readable medium of claim 9, further comprising the steps of:
determining that the parking meter has expired;
determining that the driver is going to return to the vehicle in a second amount of time; and
providing a first amount of money to the parking meter to purchase additional time on the parking meter equal to at least the second amount of time.

11. The non-transitory computer-readable medium of claim 1, wherein an autonomous drone is configured to obtain sensor data that reflects the set of parking restrictions or is configured to notify the driver to return to the vehicle.

12. The non-transitory computer-readable medium of claim 1, wherein notifying the driver to return to the vehicle comprises at least one of transmitting a short message service (SMS) message to the driver, sending an electronic mail (email) to the driver, and posting to a social media website for the driver.

13. A system, comprising:
a sensor array configured to collect sensor data; and
a computing device residing within a vehicle configured to process the sensor data, including:
a processor configured to:
obtain a set of parking restrictions that govern the use of a parking space;
obtain a set of contextual constraints associated with a driver of the vehicle; and
notify the driver to return to the vehicle based on the set of parking restrictions and the set of contextual constraints.

14. The system of claim 13, wherein the processor is further configured to:
set a timer based on the set of parking restrictions, wherein the timer indicates a first amount of time until at least one parking restriction is violated; and
generate a buffer value based on the set of contextual constraints, wherein the buffer value indicates a total amount of time the driver has to return to the vehicle.

15. The system of claim 14, wherein the set of contextual constraints comprises at least one of an amount of time the driver has to return to the vehicle, an estimated amount of delay to be incurred as the driver returns to the vehicle, and an amount of extra buffer time, and wherein the driver is notified to return to the vehicle when an amount of time remaining on the timer is equal to the buffer value.

16. The system of claim 13, wherein the sensor data comprises optical data associated with a parking sign corresponding to the parking space, and the processor is further configured to process the optical data to extract the set of parking restrictions using computer vision.

17. The system of claim 13, wherein the sensor data comprises geo-spatial positioning data from a global navigation satellite system (GNSS) associated with the parking space, and the processor is further configured to access a geocoded database to extract the set of parking restrictions.

18. The system of claim 13, further comprising an autonomous drone that includes the sensor array and is configured to wirelessly transmit the sensor data to the processor.

19. A computer implemented method for notifying a driver of a vehicle that an allotted parking time is expiring, the method comprising:
obtaining, at a computing device residing within the vehicle, a set of parking restrictions that govern the use of a parking space;
obtaining a set of contextual constraints associated with a driver of a vehicle; and
notifying the driver to return to the vehicle based on the set of parking restrictions and the set of contextual constraints.

20. The computer-implemented method of claim 19, further comprising:
setting a timer based on the set of parking restrictions that indicates a first amount of time until at least one parking restriction is violated; and
generating a buffer value based on the set of contextual constraints that indicates a total amount of time the driver has to return to the vehicle,
wherein the set of contextual constraints comprises at least one of an amount of time the driver has to return to the vehicle, an estimated amount of delay to be incurred as the driver returns to the vehicle, and an amount of extra buffer time, and
wherein the driver is notified to return to the vehicle when an amount of time remaining on the timer is equal to the buffer value.
